(19) United States
(12) Patent Application Publication
(10) Pub. No.: US 2023/0413821 A1
(43) Pub. Date: Dec. 28, 2023

(54) LIQUID PESTICIDAL COMPOSITION

(71) Applicant: SUMITOMO CHEMICAL COMPANY, LIMITED, Chuo-ku (JP)

(72) Inventors: Iki TAKETANI, Takarazuka-shi (JP); Ai RUSU, Takarazuka-shi (JP)

(73) Assignee: SUMITOMO CHEMICAL COMPANY, LIMITED, Chuo-ku (JP)

(21) Appl. No.: 18/254,805

(22) PCT Filed: Nov. 30, 2021
(86) PCT No.: PCT/JP2021/043748

§ 371 Date: May 26, 2023

(30) Foreign Application Priority Data
Dec. 1, 2020 (JP) 2020-199850

(51) Int. Cl. A01N 43/54; A01N 25/04; A01N 25/30

(52) U.S. Cl. CPC A01N 43/54; A01N 25/04; A01N 25/30

(57) ABSTRACT

Provided is a liquid pesticidal composition having favorable stability of an emulsion when mixed with water. The liquid pesticidal composition comprises (a) a compound represented by the following formula (I), and (b) one or more organic solvents selected from the group consisting of butyl propionate, benzoic acid esters, dimethyl isosorbide, 2-heptanone, benzyl acetate and butylbiphenyl.

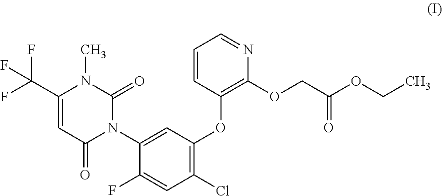 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a liquid pesticidal composition.

### BACKGROUND ART

According to U.S. Pat. No. 6,537,948 (Patent Literature 1), a compound represented by the following formula (I) (hereinafter, also called “compound (I)”), which is an active ingredient for herbicides, is known as a pesticidal active ingredient.

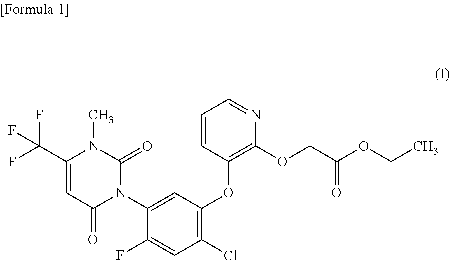 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: U.S. Pat. No. 6,537,948

### SUMMARY OF INVENTION

### Technical Problem

An object of the present invention is to provide a liquid pesticidal composition comprising a compound (I), wherein the liquid pesticidal composition has favorable stability of an emulsion when mixed with water.

### Solution to Problem

The present invention provides the following liquid pesticidal composition.
[1] A liquid pesticidal composition comprising
(a) a compound represented by the following formula (I), and
(b) one or more organic solvents selected from the group consisting of butyl propionate, benzoic acid esters, dimethyl isosorbide, 2-heptanone, benzyl acetate and butylbiphenyl:

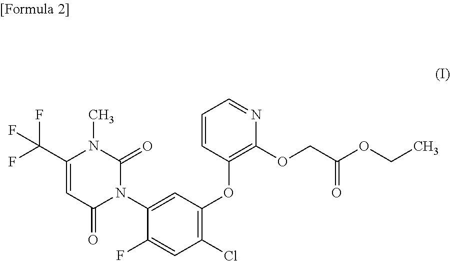 [SMILES: CCOC(=O)COc1ncccc1Oc1cc(-n2c(=O)cc(C(F)(F)F)n(C)c2=O)c(F)cc1Cl]

[2] The liquid pesticidal composition according to [1], comprising a surfactant.
[3] The liquid pesticidal composition according to [1] or [2], comprising one or more surfactants selected from the group consisting of ionic surfactants and nonionic surfactants.

### Advantageous Effects of Invention

According to the present invention, it is made possible to provide a liquid pesticidal composition comprising a compound (I), wherein the liquid pesticidal composition has favorable stability of an emulsion when mixed with water.

### DESCRIPTION OF EMBODIMENTS

A liquid pesticidal composition according to the present invention (hereinafter, also simply called “liquid pesticidal composition”) comprises
(a) a compound (I), and
(b) one or more organic solvents selected from the group consisting of butyl propionate, benzoic acid esters, dimethyl isosorbide, 2-heptanone, benzyl acetate and butylbiphenyl.

The liquid pesticidal composition can be suitably used as a liquid pesticidal formulation called emulsifiable concentrate (EC) in the pesticidal field. In the case of an emulsifiable concentrate (EC), the liquid pesticidal composition further contains a surfactant and is preferably a liquid in which all ingredients contained therein are completely or almost completely dissolved in the organic solvent.

The liquid pesticidal composition can be suitably used as a liquid pesticidal formulation called emulsion oil in water (EW) in the pesticidal field. In the case of an emulsion oil in water (EW), the liquid pesticidal composition further contains a surfactant and water and contains an aqueous phase and particles of an oil phase dispersed in the aqueous phase.

In the following, a detailed description will be given of ingredients that the liquid pesticidal composition according to the present invention contains or may contain.

(a) Compound (I)

The liquid pesticidal composition contains a compound (I) as a pesticidal active ingredient. The compound (I) is a known compound and can be produced by a known method such as a method described in U.S. Pat. No. 6,537,948.

With the total amount of the liquid pesticidal composition being taken as 100 mass %, the content of the compound (I) in the liquid pesticidal composition is generally 0.01 mass % or more and 30 mass % or less, preferably 0.1 mass % or more and 25 mass % or less, more preferably 0.5 mass % or more and 20 mass % or less, further preferably 1 mass % or more and 15 mass % or less, yet further preferably 2 mass % or more and 10 mass % or less. Other preferable ranges of the content are, for example, 3 mass % or more and 15 mass % or less, 3 mass % or more and 10 mass % or less, 3.5 mass % or more and 10 mass % or less, 5 mass % or more and 15 mass % or less or 5 mass % or more and 10 mass % or less.

Adjusting the content of the compound (I) to the above range is preferable for moderately elevating the content of the compound (I) in the liquid pesticidal composition and improving the stability of an emulsion of the liquid pesticidal composition.

(b) Organic Solvent

The liquid pesticidal composition contains at least one solvent (hereinafter, also called “organic solvent A”) selected from the group consisting of butyl propionate, benzoic acid esters, dimethyl isosorbide, 2-heptanone, benzyl acetate and butylbiphenyl (hereinafter, also called “group A”). The organic solvent A is contained, whereby a liquid pesticidal composition having favorable stability of an emulsion when mixed with water is obtained. The benzoic acid esters are preferably methyl benzoate, ethyl benzoate, butyl benzoate, and benzyl benzoate.

The liquid pesticidal composition can contain an organic solvent (hereinafter, also called “organic solvent B”) other than the organic solvent A. With the total amount of the organic solvent being taken as 100 mass %, the content of the organic solvent A is preferably 50 mass % or more, more preferably 60 mass % or more, further preferably 70 mass % or more, yet further preferably 80 mass % or more, and may be 100 mass % and may be 99 mass % or less, for improving the stability of an emulsion.

The water solubility at 25° C. of the organic solvent B is preferably 20 mass % or less and may be, for example, 10 mass % or less, may be 5 mass % or less, may be 3 mass % or less, and may be 1 mass % or less. The water solubility at 25° C. of the organic solvent B is usually 0 mass % or more and may be 10 mass % or more.

The water solubility at 25° C. herein refers to the solubility in water at a temperature of 25° C. and pH 7. For example, a water solubility at 25° C. of 10 mass % means that the solubility in 1 g of water at a temperature of 25° C. and pH 7 is 1×10⁻¹ g.

As the water solubility of the organic solvent, a value found in the database (Solubility Database) of International Union of Pure and Applied Chemistry (IUPAC) or National Institute of Standards and Technology (NIST) may be used. When a corresponding value is not found in the database, the water solubility of the organic solvent may be measured by determining the saturation solubility in water at a temperature of 25° C. and pH 7 by high-performance liquid chromatography.

Examples of the organic solvent B include:
alcohols such as hexanol, heptanol, and octanol;
esters such as methyl caproate, methyl caprylate, methyl caprate, methyl laurate, methyl myristate, methyl palmitate, methyl stearate, methyl oleate, methyl linoleate, ethyl acetate, butyl acetate, hexyl acetate, octyl acetate, dimethyl phthalate, diethyl phthalate, diethyl oxalate, dioctyl succinate, methyl salicylate, dimethyl adipate, dibutyl adipate, tert-butyl acetoacetate and allyl acetoacetate;
ethers such as propylene glycol phenyl ether;
ketones such as acetophenone;
amides such as N,N-dimethyldecanamide, N,N-dimethyldodecanamide, N,N-dimethyltetradecanamide, and N,N-dimethyloctadecanamide;
lactams such as N-octyl-pyrrolidone, N-decyl-pyrrolidone, and N-dodecyl-pyrrolidone;
aliphatic hydrocarbons such as hexane, octane, decane, tridecane, tetradecane, hexadecane, octadecane, normal paraffin, isoparaffin, cycloparaffin, 1-undecene and 1-heneicosene;
aromatic hydrocarbons such as toluene, xylene, ethylbenzene, alkylnaphthalenes (e.g., methylnaphthalene, dimethylnaphthalene, dodecylnaphthalene and tridecylnaphthalene), and mixtures thereof;
fatty acids such as caproic acid, caprylic acid, capric acid, oleic acid, linoleic acid and enanthic acid;
animal- or vegetable-derived oils such as olive oil, soybean oil, rape oil, castor oil, linseed oil, cottonseed oil, palm oil, avocado oil, coconut oil, and shark liver oil; and
mineral oils such as machine oil.

(c) Surfactant

The liquid pesticidal composition may contain one, two, or more surfactants. Examples of the surfactant include (c1) an ionic surfactant and (c2) a nonionic surfactant. Examples of the ionic surfactant include anionic surfactants, cationic surfactants and amphoteric surfactants.

Examples of the anionic surfactant include:
alkylsulfonates such as dodecylsulfonate;
alpha olefinsulfonates such as tetradecenesulfonate;
alkylarylsulfonates such as alkylbenzenesulfonate and alkylnaphthalenesulfonate;
dialkylsulfosuccinates such as di(2-ethylhexyl)sulfosuccinate;
N-acyl-N-methyltaurine salts such as oleoyl methyltaurine salt;
alkyl sulfuric acid ester salts such as lauryl sulfate;
polyoxyethylene alkyl ether sulfuric acid ester salts such as laureth sulfate;
polyoxyethylene aryl ether sulfuric acid ester salts such as polyoxyethylene distyryl phenyl ether sulfuric acid ester salt;
alkyl phosphoric acid ester salts such as lauryl phosphate;
polyoxyethylene alkyl ether phosphoric acid ester salts;
fatty acid salts such as octanoate, decanoate, laurate, palmitate, and stearate;
N-acylsarcosine salts such as oleoylsarcosine salt and stearoyl/myristoylsarcosine salt; and
N-acyl glutamate such as lauroyl glutamate and cocoyl glutamate.

Examples of the salt in the sulfonates, the sulfosuccinates, the taurine salts, the sulfuric acid ester salts, the phosphoric acid ester salts, the fatty acid salts, the sarcosine salts, and the glutamates include sodium salts, potassium salts, calcium salts, ammonium salts, isopropylamine salts, and triethanolamine salts.

Preferable examples of the anionic surfactant include alkylsulfonates, alkylarylsulfonates, alkyl sulfuric acid ester salts, dialkylsulfosuccinates, and polyoxyethylene aryl ether sulfuric acid ester salts.

Examples of the cationic surfactant include:
alkylamine hydrochlorides such as dodecylamine hydrochloride;
alkyl quaternary ammonium salts such as dodecyltrimethylammonium salt, alkyldimethylbenzylammonium salt, alkylpyridinium salt, alkylisoquinolinium salt and dialkylmorpholinium salt;
benzethonium chloride; and
polyalkylvinylpyridinium salts.

Examples of the amphoteric surfactant include N-laurylalanine, N,N,N-trimethylaminopropionic acid, N,N,N-trihydroxyethylaminopropionic acid, N-hexyl-N,N-dimethylaminoacetic acid, 1-(2-carboxyethyl)pyrimidinium betaine, and lecithin.

Examples of the nonionic surfactant include:
polyoxyalkylene block copolymers such as polyoxyethylene polyoxypropylene block copolymers;
polyoxyalkylene fatty acid esters such as polyoxyethylene fatty acid ester and polyoxyethylene polyoxypropylene fatty acid ester;
polyoxyalkylene alkyl ethers such as polyoxyethylene alkyl ether and polyoxyethylene polyoxypropylene alkyl ether;
polyoxyalkylene polyaryl ethers such as polyoxyethylene tristyryl phenyl ether, polyoxyethylene polyaryl ether and polyoxyethylene polyoxypropylene polyaryl ether;
polyoxyalkylene alkyl aryl ethers such as polyoxyethylene alkyl aryl ether and polyoxyethylene polyoxypropylene alkyl aryl ether;
polyoxyalkylene vegetable oils such as polyoxyethylene castor oil and polyoxyethylene polyoxypropylene castor oil;
polyoxyalkylene hydrogenated vegetable oils such as polyoxyethylene hydrogenated castor oil;
copolymers of polyester resins (e.g., alkyd resin) and polyethylene glycol;
glycerin fatty acid esters;
sorbitan fatty acid esters such as sorbitan laurate, sorbitan stearate, sorbitan oleate and sorbitan trioleate;
polyoxyalkylene sorbitan fatty acid esters such as polyoxyethylene sorbitan laurate, polyoxyethylene sorbitan stearate, polyoxyethylene sorbitan oleate and polyoxyethylene sorbitan trioleate; and
alkoxylated amines such as alkoxylate ethylenediamine.

Preferable examples of the nonionic surfactant include polyoxyalkylene block copolymers, polyoxyalkylene alkyl ethers, polyoxyalkylene polyaryl ethers, polyoxyalkylene vegetable oils, copolymers of alkyd resin and polyethylene glycol, sorbitan fatty acid esters, and polyoxyalkylene sorbitan fatty acid esters.

(d) Other Ingredients

The liquid pesticidal composition can optionally contain an additional ingredient other than those described above.

Examples of other ingredients include pesticidal active ingredients other than the compound (I) and formulation aids.

With the total amount of the pesticidal active ingredient contained in the liquid pesticidal composition being taken as 100 mass %, the content of the compound (I) in all the pesticidal active ingredients contained in the liquid pesticidal composition may be, for example, 1 mass % or more and 100 mass % or less or 3 mass % or more and 100 mass % or less. The content is, for example, 5 mass % or more and 100 mass % or less, mass % or more and 100 mass % or less, 15 mass % or more and 100 mass % or less, mass % or more and 100 mass % or less or 30 mass % or more and 100 mass % or less.

Examples of the pesticidal active ingredient other than the compound (I) include, but are not particularly limited to, insecticidal active ingredients, fungicidal active ingredients and herbicidal active ingredients. The liquid pesticidal composition can contain one or more pesticidal active ingredients selected from the group consisting of insecticidal active ingredients, fungicidal active ingredients and herbicidal active ingredients as the pesticidal active ingredient other than the compound (I). Each of the insecticidal active ingredient, the fungicidal active ingredient and the herbicidal active ingredient may comprise one, two, or more ingredients.

Examples of the herbicidal active ingredient that may be further contained, in addition to the compound (I), in the liquid pesticidal composition include the following. These may be mixed, for use, into the liquid pesticidal composition containing the compound (I) as a pesticidal active ingredient.

Herbicides: 2,3,6-TBA (2,3,6-trichlorobenzoic acid), 2,3,6-TBA-dimethylammonium, 2,3,6-TBA-lithium, 2,3,6-TBA-potassium, 2,3,6-TBA-sodium, 2,4-D, 2,4-D choline salt, 2,4-D-biproamine, 2,4-D-doboxyl, 2,4-D-2-ethylhexyl, 2,4-D-3-butoxypropyl, 2,4-D-ammonium, 2,4-D-butotyl, 2,4-D-butyl, 2,4-D-diethylammonium, 2,4-D-dimethylammonium, 2,4-D-diolamine, 2,4-D-dodecylammonium, 2,4-D-ethyl, 2,4-D-heptylammonium, 2,4-D-isobutyl, 2,4-D-isoctyl, 2,4-D-isopropyl, 2,4-D-isopropylammonium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 2,4-DB, 2,4-DB choline salt, 2,4-DB-biproamine, 2,4-DB-butyl, 2,4-DB-dimethylammonium, 2,4-DB-isoctyl, 2,4-DB-potassium, 2,4-DB-sodium, acetochlor, acifluorfen, acifluorfen-sodium, aclonifen, ACN (2-amino-3-chloronaphthalene-1,4-dione), alachlor, allidochlor, alloxydim, ametryn, amicarbazone, amidosulfuron, aminocyclopyrachlor, aminocyclopyrachlor-methyl, aminocyclopyrachlor-potassium, aminopyralid, aminopyralid choline salt, aminopyralid-potassium, aminopyralid-tripromine, amiprophos-methyl, amitrole, anilofos, asulam, atrazine, azafenidin, azimsulfuron, beflubutamid, benazolin-ethyl, bencarbazone, benfluralin, benfuresate, bensulfuron, bensulfuron-methyl, bensulide, bentazon, benthiocarb, benzfendizone, benzobicyclon, benzofenap, benzthiazuron, bialaphos, bicyclopyrone, bifenox, bispyribac, bispyribac-sodium, bixlozone, bromacil, bromobutide, bromofenoxim, bromoxynil, bromoxynil-octanoate, butachlor, butafenacil, butamifos, butralin, butroxydim, butylate, cafenstrole, carbetamide, carfentrazone, carfentrazone-ethyl, chlomethoxyfen, chloramben, chloridazon, chlorimuron, chlorimuron-ethyl, chlorobromuron, chlorotoluron, chloroxuron, chlorpropham, chlorsulfuron, chlorthal-dimethyl, chlorthiamid, cinidon, cinidon-ethyl, cinmethylin, cinosulfuron, clethodim, clodinafop, clodinafop-propargyl, clomazone, clomeprop, clopyralid, clopyralid choline salt, clopyralid-methyl, clopyralid-olamine, clopyralid-potassium, clopyralid-tris(2-hydroxypropyl)ammonium, cloransulam, cloransulam-methyl, cumyluron, cyanazine, cyclopyranil, cycloate, cyclopyrimorate, cyclosulfamuron, cycloxydim, cyhalofop, cyhalofop-butyl, daimuron, dalapon, dazomet, desmedipham, desmetryn, di-allate, dicamba, dicamba choline salt, dicamba-biproamine, dicamba-trolamine, dicamba-diglycolamine, dicamba-dimethylammonium, dicamba-diolamine, dicamba-isopropylammonium, dicamba-methyl, dicamba-olamine, dicamba-potassium, dicamba-sodium, dichlobenil, dichlorprop, dichlorprop choline salt, dichlorprop-biproamine, dichlorprop-etexyl, dichlorprop-butotyl, dichlorprop-dimethylammonium, dichlorprop-ethylammonium, dichlorprop-isoctyl, dichlorprop-methyl, dichlorprop-P, dichlorprop-P choline salt, dichlorprop-P-biproamine, dichlorprop-P-etexyl, dichlorprop-P-dimethylammonium, dichlorprop-potassium, dichlorprop-sodium, diclofop, diclofop-methyl, diclosulam, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimepiperate, dinitramine, dinoseb, dinoterb, diphenamid, diquat, diquat-dibromide, DSMA (disodium methylarsonate), dithiopyr, diuron, DNOC (2-methyl-4,6-dinitrophenol), esprocarb, ethalfluralin, ethametsulfuron, ethametsulfuron-methyl, ethidimuron, ethofumesate, ethoxyfen-ethyl, ethoxysulfuron, etobenzanid, fenoxaprop, fenoxaprop-ethyl, fenoxaprop-P, fenoxaprop-P-ethyl, fenoxasulfone, fenquinotrione, fentrazamide, fenuron, flamprop-M, flazasulfuron, florasulam, florpyrauxifen, florpyrauxifen-benzyl, fluazifop, fluazifop-butyl, fluazifop-P, fluazifop-P-butyl, fluazolate, flucarbazone, flucarbazone-sodium, flucetosulfuron, flufenacet, flufenpyr, flufenpyr-ethyl, flumetsulam, flumiclorac, flumiclorac-pentyl, flumioxazin, fluometuron, fluoroglycofen-ethyl, flupoxam, flupropanate, flupyrsulfuron, flupyrsulfuron-methyl-sodium, flurenol, fluridone, flurochloridone, fluroxypyr, fluroxypyr-butometyl, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P, glufosinate-P-ammonium, glufosinate-P-sodium, glyphosate, glyphosate choline salt, glyphosate-isopropylammonium, glyphosate-biproamine, glyphosate-ammonium, glyphosate-diammonium, glyphosate-potassium, glyphosate-sodium, glyphosate-trimesium, halauxifen, halauxifen-methyl, halosafen, halosulfuron, halosulfuron-methyl, haloxyfop, haloxyfop-etotyl, haloxyfop-methyl, haloxyfop-P, haloxyfop-P-etotyl, haloxyfop-P-methyl, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-ammonium, imazosulfuron, indanofan, indaziflam, iodosulfuron, iodosulfuron-methyl-sodium, iofensulfuron, iofensulfuron-sodium, ioxynil, ioxynil-octanoate, ipfencarbazone, isoproturon, isouron, isoxaben, isoxachlortole, isoxaflutole, lactofen, lenacil, linuron, maleic hydrazide, MCPA (2-(4-chloro-2-methylphenoxy)acetic acid), MCPA choline salt, MCPA-biproamine, MCPA-etexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-sodium, MCPA-trolamine, MCPB (4-(4-chloro-2-methylphenoxy)butanoic acid), MCPB choline salt, MCPB-biproamine, MCPB-ethyl, MCPB-methyl, MCPB-sodium, mecoprop, mecoprop choline salt, mecoprop-biproamine, mecoprop-2-ethylhexyl, mecoprop-dimethylammonium, mecoprop-diolamine, mecoprop-ethadyl, mecoprop-isoctyl, mecoprop-methyl, mecoprop-potassium, mecoprop-sodium, mecoprop-trolamine, mecoprop-P, mecoprop-P choline salt, mecoprop-P-2-ethylhexyl, mecoprop-P-dimethylammonium, mecoprop-P-isobutyl, mecoprop-P-potassium, mefenacet, mesosulfuron, mesosulfuron-methyl, mesotrione, metam, metamifop, metamitron, metazachlor, metazosulfuron, methabenzthiazuron, methiozolin, methyldymron, metobromuron, metolachlor, metosulam, metoxuron, metribuzin, metsulfuron, metsulfuron-methyl, molinate, monolinuron, naproanilide, napropamide, napropamide-M, naptalam, neburon, nicosulfuron, norflurazon, oleic acid, orbencarb, orthosulfamuron, oryzalin, oxadiargyl, oxadiazon, oxasulfuron, oxaziclomefone, oxyfluorfen, paraquat, paraquat-dichloride, pebulate, pelargonic acid, pendimethalin, penoxsulam, pentanochlor, pentoxazone, pethoxamid, phenisopham, phenmedipham, picloram, picolinafen, pinoxaden, piperophos, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen-ethyl, pyrasulfotole, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quizalofop, quizalofop-ethyl, quizalofop-tefuryl, quizalofop-P, quizalofop-P-ethyl, quizalofop-P-tefuryl, rimsulfuron, saflufenacil, sethoxydim, EPTC (S-ethyl N,N-dipropylcarbamothioate), siduron, simazine, simetryn, S-metolachlor, MSMA (sodium hydrogen methylarsonate), sulcotrione, sulfentrazone, sulfometuron, sulfometuron-methyl, sulfosulfuron, swep, TCA (2,2,2-trichloroacetic acid), TCA-ammonium, TCA-calcium, TCA-ethadyl, TCA-magnesium, TCA-sodium, tebutam, tebuthiuron, tefuryltrione, tembotrione, tepraloxydim, terbacil, terbumeton, terbuthylazine, terbutryn, tetflupyrolimet, thaxtomin A, thenylchlor, thiazopyr, thidiazimin, thiencarbazone, thiencarbazone-methyl, thifensulfuron, thifensulfuron-methyl, tiafenacil, tiocarbazil, tolpyralate, topramezone, tralkoxydim, triafamone, tri-allate, triasulfuron, triaziflam, tribenuron, tribenuron-methyl, triclopyr, triclopyr-butotyl, triclopyr-ethyl, triclopyr-triethylammonium, tridiphane, trietazine, trifloxysulfuron, trifloxysulfuron-sodium, trifludimoxazin, trifluralin, triflusulfuron, triflusulfuron-methyl, tritosulfuron, vernolate, 4-(4-fluorophenyl)-6-[(2-hydroxy-6-oxo-1-cyclohexen-1-yl)carbonyl]-2-methyl-1,2,4-triazine-3,5(2H,4H)-dione, 2-chloro-N-(1-methyl-1H-tetrazol-5-yl)-3-(methylthio)-4-(trifluoromethyl)benzamide, 2-methyl-N-(5-methyl-1,3,4-oxadiazol-2-yl)-3-(methanesulfonyl)-4-(trifluoromethyl)benzamide, 4-amino-3-chloro-5-fluoro-6-(7-fluoro-1H-indol-6-yl)pyridine-2-carboxylic acid, 4-amino-3-chloro-5-fluoro-6-(7-fluoro-1H-indol-6-yl)pyridine-2-carboxylic acid cyanomethyl ester, (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester, (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester, 3-[(isopropylsulfonypmethyl]-N-(5-methyl-1,3,4-oxadiazol-2-yl)-5-(tifluoromethyl)-1,2,4-triazolo[4,3-a]pyridine-8-carboxamide, 1-{2-chloro-6-[(5-chloropyrimidin-2-yl)oxy]phenyl}-4,4,4-trifluorobutan-1-one, and 5-chloro-2-{3-chloro-2-[5-(difluoromethyl)isoxazol-3-yl]phenoxy}pyrimidine.

In the present invention, the herbicidal active ingredient that can be used in combination with the liquid pesticidal composition is particularly preferably glyphosate potassium salt, glyphosate dimethylamine salt, glyphosate monoethanolamine salt, glufosinate ammonium salt, glufosinate P ammonium salt, glyphosate isopropylammonium salt, 2,4-D choline salt, 2,4-D dimethylammonium, dicamba diglycolamine salt, dicamba BAPMA salt, dicamba tetrabutylamine salt, dicamba tetrabutylphosphonium salt, pyroxasulfone, flumioxazin, flumiclorac pentyl, clethodim, lactofen, S metolachlor, metribuzin, flufenacet, nicosulfuron, rimsulfuron, acetochlor, mesotrione, isoxaflutole, chlorimuron ethyl, thifensulfuron methyl, cloransulam methyl, and imazethapyr ammonium salt.

Examples of the formulation aid include antifoaming agents and thickeners. Examples of the antifoaming agent include silicone-based antifoaming agents.

When the liquid pesticidal composition contains an antifoaming agent, its content, with the total amount of the liquid pesticidal composition being taken as 100 mass %, is usually 0.001 mass % or more and 1 mass % or less, preferably 0.002 mass % or more and 0.8 mass % or less.

Examples of the thickener include thickeners soluble in an organic solvent or dispersible in an organic solvent. Examples of the thickener soluble in an organic solvent or dispersible in an organic solvent include organic clay, organic bentonite, organic montmorillonite, and organically modified castor oil derivatives.

When the liquid pesticidal composition contains a thickener, its content, with the total amount of the liquid pesticidal composition being taken as 100 mass %, is usually 0.01 mass % or more and 20 mass % or less.

(e) Production and Use of Liquid Pesticidal Composition (Emulsifiable Concentrate)

The liquid pesticidal composition can be suitably used as a liquid pesticidal formulation called emulsifiable concentrate (EC) in the pesticidal field. When the liquid pesticidal composition is an emulsifiable concentrate (hereinafter, also simply called “emulsifiable concentrate”), preferable embodiments will be described.

With the total amount of the emulsifiable concentrate being taken as 100 mass %, the total content of the compound (I), the organic solvent, and the surfactant in the emulsifiable concentrate is preferably 60 mass % or more, more preferably 70 mass % or more, further preferably 75 mass % or more. The total content may be 100 mass %, may be 95 mass % or less, may be 90 mass % or less, and may be 85 mass % or less.

With the total amount of the emulsifiable concentrate being taken as 100 mass %, the content of the organic solvent in the emulsifiable concentrate is preferably 10 mass % or more and 90 mass % or less, more preferably 30 mass % or more and 88 mass % or less, further preferably 50 mass % or more and 85 mass % or less.

The content of the organic solvent relative to the content of the compound (I) is usually 3 times by mass or more and 50 times by mass or less, preferably 4 times by mass or more and 40 times by mass or less, more preferably 5 times by mass or more and 30 times by mass or less.

Adjusting the ratio (mass ratio) of the content of the organic solvent to the content of the compound (I) to the above range is preferable for improving emulsion stability when the emulsifiable concentrate is mixed with water.

With the total amount of the emulsifiable concentrate being taken as 100 mass %, the total content of the ionic surfactant and the nonionic surfactant in the emulsifiable concentrate is preferably 1 mass % or more and 30 mass % or less, more preferably 2 mass % or more and 28 mass % or less, further preferably 4 mass % or more and 26 mass % or less, yet further preferably 6 mass % or more and 24 mass % or less, particularly preferably 8 mass % or more and 22 mass % or less.

The total content of the ionic surfactant and the nonionic surfactant relative to the content of the compound (I) is preferably 0.1 times by mass or more and 30 times by mass or less, more preferably 0.5 times by mass or more and 20 times by mass or less, further preferably 1 time by mass or more and 10 times by mass or less.

When the emulsifiable concentrate contains one or more nonionic surfactants and one or more ionic surfactants, the content ratio (mass ratio) between the one or more nonionic surfactants and the one or more ionic surfactants is preferably from 1:0.05 to 1:40, more preferably from 1:0.1 to 1:30, further preferably from 1:0.2 to 1:20.

The liquid pesticidal composition which is an emulsifiable concentrate can be produced by a general method as a method for producing an emulsifiable concentrate, and can be produced, for example, by mixing the compound (I), the organic solvent, and the surfactant, and an optional ingredient.

The liquid pesticidal composition which is an emulsifiable concentrate is applied to control pests or weeds by a method usually used for emulsifiable concentrates. Specifically, the emulsifiable concentrate is mixed with water to prepare an emulsified liquid, and the emulsified liquid is applied to a plant or soil in which a plant is grown.

The emulsified liquid is prepared by mixing the emulsifiable concentrate with water in usually from 2 to 10000 times, preferably from 10 to 8000 times, more preferably from 15 to 6000 times the volume of the emulsifiable concentrate.

In applying the emulsified liquid, it may be mixed with an adjuvant. Although the type of the adjuvant is not particularly limited, it is desirable to mix an oil-based adjuvant (methylated seed oil in which a mineral oil such as a paraffinic hydrocarbon, a naphthenic hydrocarbon, or an aromatic hydrocarbon, or a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift control agent such as Intact (polyethylene glycol) or a volatilization-reducing agent such as Vapex, a VaporGrip Xtra Agent (mixture of potassium hydroxide and acetic acid) may be mixed. The pH or hardness of the spray liquid is not particularly limited.

(f) Production and Use of Liquid Pesticidal Composition (Emulsion Oil in Water)

The liquid pesticidal composition can be suitably used as a liquid pesticidal formulation called emulsion oil in water (EW) in the pesticidal field. When the liquid pesticidal composition is an emulsion oil in water (hereinafter, also simply called “emulsion oil in water”), preferable embodiments will be described.

The emulsion oil in water contains water. Examples of the water include ion-exchange water, tap water and groundwater. The water constitutes the aqueous phase of the emulsion oil in water.

With the total amount of the emulsion oil in water being taken as 100 mass %, the content of the water in the emulsion oil in water is preferably 40 mass % or more and 95 mass % or less, more preferably 50 mass % or more and 93 mass % or less, further preferably 60 mass % or more and 90 mass % or less, yet further preferably 70 mass % or more and 87 mass % or less. For improving the stability of an emulsion of the liquid pesticidal composition, it is preferable that the emulsion oil in water contain water at a content within the range.

The emulsion oil in water is an oil-in-water emulsion containing an aqueous phase and oil phase particles dispersed in the aqueous phase.

The liquid pesticidal composition which is an emulsion oil in water can be produced by a general method as a method for producing an emulsion oil in water. For example, the compound (I), the organic solvent, and the surfactant are mixed to prepare an oil phase. A pesticidal active compound other than the compound (I), a formulation aid and water are added to prepare an aqueous phase. In this respect, the surfactant may be added to the organic solvent, may be added to the water, or may be added to both. The oil phase is added to the aqueous phase and emulsified using a stirrer such as a homogenizer, and the resultant is mixed with an optional formulation aid such as a thickener, an antiseptic, and an antifoaming agent to obtain the composition of the present invention.

The liquid pesticidal composition which is an emulsion oil in water is applied to control pests or weeds by a method usually used for emulsion oils in water. In applying the emulsion oil in water, it may be mixed with an adjuvant, as in the emulsifiable concentrate.

### EXAMPLES

In the following, the present invention will be described in further detail with reference to Examples. The scope of the present invention is not limited to these Examples.

### Preparation of Emulsifiable Concentrate

### (1) Preparation of Emulsifiable Concentrates of Production Examples 1 to 18 and Comparative Production Examples 1 and 2

The ingredients specified in Tables 1 and 2 were mixed in the mass ratio specified in Tables 1 and 2 and stirred into a homogeneous solution to obtain emulsifiable concentrates of Production Examples 1 to 18 and Comparative Production Examples 1 and 2.

<Evaluation of Emulsifiable Concentrate (Emulsion Stability when Mixed with Water)>

In an environment at room temperature, 99 mL of CIPAC Standard Water D (hardness, 342 ppm) at 30° C. was added to a 100-mL measuring cylinder with a cap, and, from a height of about 1 cm from the water surface, 1 mL of the emulsifiable concentrate was slowly added dropwise. With the cap on, the measuring cylinder was inverted by 180° over 1 second and then inverted back to the original position over 1 second, and this operation was repeated 10 times in total. Then, the measuring cylinder was left standing in a thermostatic water bath at 30° C. for 72 hours. After this, the state inside the measuring cylinder was visually examined, and emulsion stability when mixed with water was evaluated according to the below evaluation criteria. Evaluation results are shown in Tables 1 and 2. When rated as A or B, it is considered that crystal deposition or growth tends not to occur, leading to an evaluation that the emulsion stability when mixed with water is excellent.
A: The dilution was homogeneous, and no crystal deposition was observed.
B: Although creaming was observed, no crystal deposition was observed.
C: Crystal deposition was observed.

TABLE 1

| | | | | | | | | | | | Comparative |
|---|---|---|---|---|---|---|---|---|---|---|---|
| | | | | | | | | | | | Production |
| | | Production Example | | | | | | | | | Example |
| | | 1 | 2 | 3 | 4 | 5 | 6 | 7 | 8 | 9 | 1 |
| Pesticidal active ingredient | Compound (I) | 10 | 10 | 10 | 10 | 10 | 10 | 10 | 10 | 10 | 10 |
| Surfactant | Emulsogen TS290 | 14 | 14 | 14 | 14 | 14 | 14 | 14 | 14 | 14 | 14 |
| | Phenylsulfonat CAL | 6 | 6 | 6 | 6 | 6 | 6 | 6 | 6 | 6 | 6 |
| Solvent | 2-Heptanone | 70 | | | | | | | | | |
| | Benzyl acetate | | 70 | | | | | | | | |
| | Butyl propionate | | | 70 | | | | | | | |
| | Methyl benzoate | | | | 70 | | | | | | |
| | Ethyl benzoate | | | | | 70 | | | | | |
| | Butyl benzoate | | | | | | 70 | | | | |
| | Benzyl benzoate | | | | | | | 70 | | | |
| | Dimethyl isosorbide | | | | | | | | 70 | | |
| | Butylbiphenyl | | | | | | | | | 70 | |
| | Xylene | | | | | | | | | | 35 |
| | Cyclohexanone | | | | | | | | | | 35 |
| Total (w/w %) | | 100 | 100 | 100 | 100 | 100 | 100 | 100 | 100 | 100 | 100 |
| Emulsion stability | Temperature: 30° C. | B | B | A | B | B | B | B | B | B | C |
| (×100) | Still standing time: | | | | | | | | | | |
| | 72 hr | | | | | | | | | | |

TABLE 2

| | | | | | | | | | | | Comparative |
|---|---|---|---|---|---|---|---|---|---|---|---|
| | | | | | | | | | | | Production |
| | | Production Example | | | | | | | | | Example |
| | | 10 | 11 | 12 | 13 | 14 | 15 | 16 | 17 | 18 | 2 |
| Pesticidal active ingredient | Compound (I) | 10 | 10 | 10 | 10 | 10 | 10 | 10 | 10 | 10 | 10 |
| Surfactant | Atlas G-5000 | 5 | 5 | 5 | 5 | 5 | 5 | 5 | 5 | 5 | 5 |
| | Atlox 4914 | 5 | 5 | 5 | 5 | 5 | 5 | 5 | 5 | 5 | 5 |
| Solvent | 2-Heptanone | 80 | | | | | | | | | |
| | Benzyl acetate | | 80 | | | | | | | | |
| | Butyl propionate | | | 80 | | | | | | | |
| | Methyl benzoate | | | | 80 | | | | | | |
| | Ethyl benzoate | | | | | 80 | | | | | |
| | Butyl benzoate | | | | | | 80 | | | | |
| | Benzyl benzoate | | | | | | | 80 | | | |
| | Dimethyl isosorbide | | | | | | | | 80 | | |
| | Butylbiphenyl | | | | | | | | | 80 | |
| | Xylene | | | | | | | | | | 40 |
| | Cyclohexanone | | | | | | | | | | 40 |
| Total (w/w %) | | 100 | 100 | 100 | 100 | 100 | 100 | 100 | 100 | 100 | 100 |
| Emulsion stability | Temperature: 30° C. | B | B | B | B | B | B | B | B | B | C |
| (×100) | Still standing time: | | | | | | | | | | |
| | 72 hr | | | | | | | | | | |

The details of the ingredients specified in Tables 1 and 2 are as follows:
Emulsogen TS290 (polyoxyethylene tristyryl phenyl ether, manufactured by Clariant),
Phenylsulfonat CAL (mixture of 70% calcium dodecylbenzenesulfonate and 30% iso-butanol, manufactured by Clariant),
Atlas G5000 (polyoxyalkylene block copolymer, manufactured by Croda),
Atlox 4914 (copolymer of alkyd resin and polyethylene glycol, manufactured by Croda),
2-heptanone (manufactured by FUJIFILM Wako Pure Chemical Corp.),
benzyl acetate (trade name: JEFFSOL AG1705, manufactured by Huntsman),
butyl propionate (manufactured by FUJIFILM Wako Pure Chemical Corp.),
methyl benzoate (manufactured by FUJIFILM Wako Pure Chemical Corp.),
ethyl benzoate (manufactured by FUJIFILM Wako Pure Chemical Corp.),
butyl benzoate (trade name: JEFFSOL AG1700, manufactured by Huntsman),
benzyl benzoate (manufactured by FUJIFILM Wako Pure Chemical Corp.),
dimethyl isosorbide (manufactured by FUJIFILM Wako Pure Chemical Corp.),
butylbiphenyl (4-butylbiphenyl, manufactured by FUJIFILM Wako Pure Chemical Corp.)
xylene (manufactured by FUJIFILM Wako Pure Chemical Corp.), and
cyclohexanone (manufactured by FUJIFILM Wako Pure Chemical Corp.).

1. A liquid pesticidal composition comprising
(a) a compound represented by the following formula (I), and
(b) one or more organic solvents selected from the group consisting of butyl propionate, benzoic acid esters, dimethyl isosorbide, 2-heptanone, benzyl acetate and butylbiphenyl:

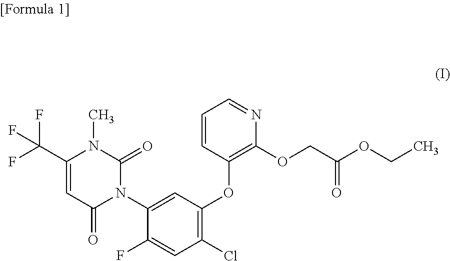 [SMILES: CCOC(=O)COc1ncccc1Oc1cc(-n2c(=O)cc(C(F)(F)F)n(C)c2=O)c(F)cc1Cl]

2. The liquid pesticidal composition according to claim 1, comprising a surfactant.

3. The liquid pesticidal composition according to claim 1, comprising one or more surfactants selected from the group consisting of ionic surfactants and nonionic surfactants.

4. The liquid pesticidal composition according to claim 2, comprising one or more surfactants selected from the group consisting of ionic surfactants and nonionic surfactants.
